(19) United States
(12) Patent Application Publication
(10) Pub. No.: US 2023/0185022 A1
(43) Pub. Date: Jun. 15, 2023

(54) LENS WITH ALIGNMENT FACETS

(71) Applicant: Intel Corporation, Santa Clara, CA (US)

(72) Inventor: John HECK, Berkeley, CA (US)

(21) Appl. No.: 17/549,506

(22) Filed: Dec. 13, 2021

(51) Int. Cl. G02B 6/122; G02B 6/136

(52) U.S. Cl. CPC G02B 6/122; G02B 6/136

(57) ABSTRACT

Embodiments herein relate to systems, apparatuses, or processes for a silicon lens manufactured on a 110-oriented silicon wafer that includes highly accurate vertical alignment features on the edges of the silicon lens created using crystallographic etching. In embodiments, these vertical alignment features are revealed 111 planes in the silicon wafer. Other embodiments may be described and/or claimed.

### FIELD

Embodiments of the present disclosure generally relate to the field of optical package assemblies, and in particular coupling optical lenses with photonic integrated circuits (PIC).

### BACKGROUND

Continued reduction in end product size of mobile electronic devices such as smart phones and ultrabooks and increased requirements for performance is increasing the adoption of optical technologies within these devices.

### BRIEF DESCRIPTION OF THE DRAWINGS

FIG. 1 illustrates various perspective views of a silicon lens with alignment facets, a PIC, and a silicon lens with alignment facets coupled with a PIC, in accordance with various embodiments.

FIG. 2 illustrates various cross section side views of a silicon lens with alignment facets coupled with a PIC, in accordance with various embodiments.

FIG. 3 illustrates various cross section front views of a silicon lens with alignment facets coupled with a PIC, in accordance with various embodiments.

FIGS. 4A-4F illustrate stages in the manufacturing process for creating a silicon lens with alignment facets using crystallographical etching, in accordance with various embodiments.

FIGS. 5A-5B schematically illustrate a top view of an example die in wafer form and in singulated form, and a cross section side view of a package assembly, in accordance with various embodiments.

FIG. 6 illustrates an example of a process for creating a silicon lens with alignment facets using crystallographical etching, in accordance with various embodiments.

FIG. 7 schematically illustrates a computing device, in accordance with embodiments.

### DETAILED DESCRIPTION

Embodiments of the present disclosure may generally relate to systems, apparatus, techniques, and/or processes directed to a silicon lens that includes highly accurate vertical alignment features on the edges of the silicon lens using crystallographic etching. In embodiments, these vertical alignment features may be referred to as vertical alignment facets. In embodiments, the silicon lens may be manufactured on a 110-oriented silicon wafer. In embodiments, vertical features may then be manufactured into the silicon wafer using crystallographic etchants that reveal a 111 plane in the silicon wafer. These resulting 111 planes may then be used to align a vertical position of a 90° rotated silicon lens to a surface, or a datum, on a PIC wafer.

To couple light from the edge of a PIC to a fiber or waveguide on a substrate, it is important to accurately align a silicon lens whose optical axis is 90° rotated with respect to the PIC. Embodiments described herein include fabricating a vertical alignment facet on the silicon lens that is lithographically defined, truly vertical, and crystallographically smooth.

In embodiments, a silicon lens with vertical alignment facets may enable highly accurate passive alignment of the silicon lens to expand and collimate a beam of light coming from an edge of a PIC, or from any other photonics chip. In embodiments, the silicon lens the PIC may be subsequently attached with a fiber attached unit (FAU). Embodiments may result in more accurate passive alignment than what may be achieved with legacy implementations.

For example, in legacy implementations, passive alignment between a PIC and fiber is done with mechanical alignment features such as V-grooves that are formed by 111 planes of silicon. Alignment features that use V-grooves typically involve a significantly larger die size, and result in difficulty inserting any additional optical components, such as optical isolators, between the PIC and the optical fiber. In other legacy implementations, silicon lens edges may be sawn or plasma-etched.

In the following detailed description, reference is made to the accompanying drawings which form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use perspective-based descriptions such as top/bottom, in/out, over/under, and the like. Such descriptions are merely used to facilitate the discussion and are not intended to restrict the application of embodiments described herein to any particular orientation.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

The term “coupled with,” along with its derivatives, may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. The term “directly coupled” may mean that two or more elements are in direct contact.

Various operations may be described as multiple discrete operations in turn, in a manner that is most helpful in understanding the claimed subject matter. However, the order of description should not be construed as to imply that these operations are necessarily order dependent.

As used herein, the term “module” may refer to, be part of, or include an ASIC, an electronic circuit, a processor (shared, dedicated, or group) and/or memory (shared, dedicated, or group) that execute one or more software or firmware programs, a combinational logic circuit, and/or other suitable components that provide the described functionality.

Various Figures herein may depict one or more layers of one or more package assemblies. The layers depicted herein are depicted as examples of relative positions of the layers of the different package assemblies. The layers are depicted for the purposes of explanation, and are not drawn to scale. Therefore, comparative sizes of layers should not be assumed from the Figures, and sizes, thicknesses, or dimensions may be assumed for some embodiments only where specifically indicated or discussed.

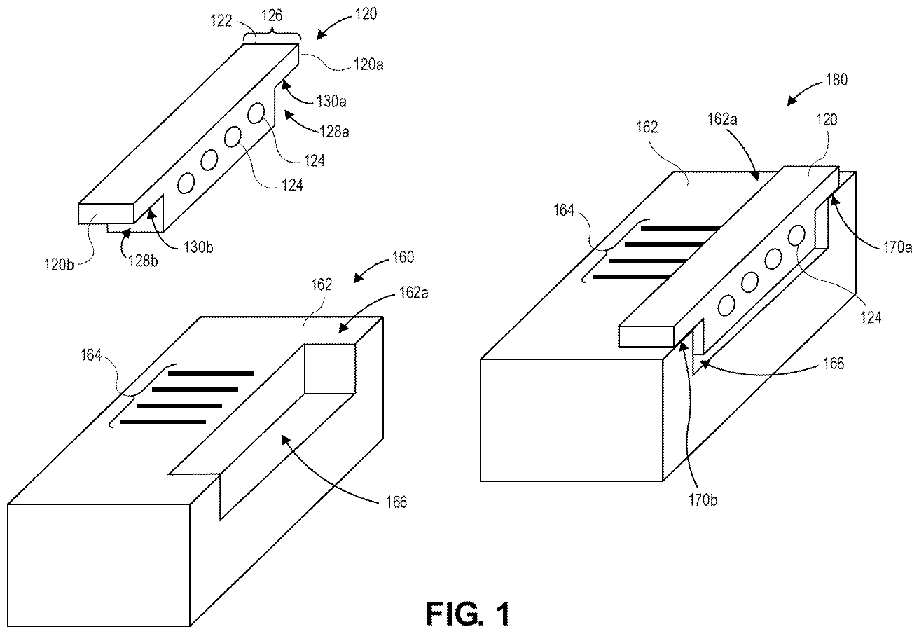

FIG. 1 illustrates various perspective views of a silicon lens with alignment facets, a PIC, and a silicon lens with alignment facets coupled with a PIC, in accordance with various embodiments. Silicon lens 120 includes a housing 122, which may include silicon, and may include one or more lenses 124. In embodiments, a width 126 of the housing 122 may vary, for example the width 126 may be narrow enough so that only the one or more lenses 124 are within housing 122. In other embodiments, a width 126 may be wider, such that a plurality of waveguides (not shown) within the housing 122 may optically couple with the plurality of lenses 124 and optically couple with a back side of the silicon lens 120 opposite the plurality of lenses 124.

In embodiments, the silicon lens 120 may have a first edge 120a and a second edge 120b opposite the first edge 120a. Cavities 128a, 128b, respectively, may be formed through crystallographical etching, as discussed further below. As a result, alignment facets 130a, 130b, respectively may be formed at the top of the cavities 128a, 128b. In embodiments, the alignment facets 130a, 130b may be used to place the silicon lens 120 with a high degree of accuracy into an opening in another die, such as PIC 162 as described below.

An embodiment of a photonics die 160 is shown, which may include a PIC 162. In embodiments, the PIC 162 may include one or more optical paths 164, for example optical waveguides, that may lead up to an opening 166 on an edge of the PIC 162. In embodiments, a top surface 162a of the PIC 162 may be planar, flat, and smooth.

Photonics package 180 is an embodiment where the silicon lens 120 is placed within the cavity 166 of the PIC 162. As a result of the design of the alignment facets 130a, 130b, the silicon lens 120 sits on the top surface 162a of the PIC 162 at contact points 170a, 170b, and accurately aligns the one or more lenses 124, respectively, with the one or more optical paths 164. It should be noted that the one or more optical paths 164 are shown at a top of the PIC 162, however they may be located elsewhere within the PIC 162. In embodiments, one or more optical couplers (not shown) may be used in addition to or in place of the one or more optical paths 164, requiring an accurate alignment with the one or more lenses 124.

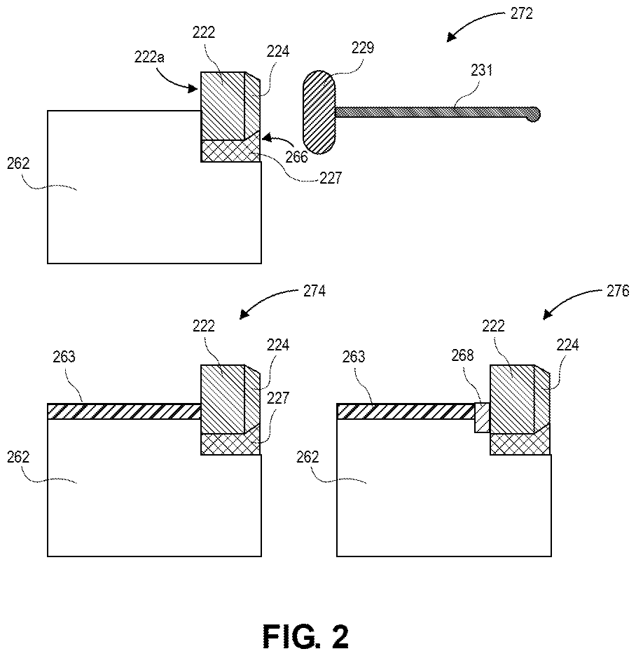

FIG. 2 illustrates various cross section side views of a silicon lens with alignment facets coupled with a PIC, in accordance with various embodiments. Cross section side view 272 may include a portion of a PIC 262, a portion of a silicon lens housing 222, and a lens 224 coupled with the housing 222. These may be similar to PIC 162, housing 122, and lens 124 of FIG. 1. In embodiments, a back edge 222a of the housing 222 may abut a portion of the PIC 262. In other embodiments, there may be a gap between the back edge 222a and the PIC 262. In embodiments, an epoxy 227 may be placed below the housing 222 in order to support the housing 222 within the cavity 266 of the PIC 262, which may be similar to cavity 166 of FIG. 1. In embodiments, some other supporting material may be used in place of the epoxy 227. In embodiments, light emitting from the lens 224 may be collimated, after which it may go through an optical filter 229, for example an optical isolator, prior to passing along a connecting optical path 231 to another component, such as a FAU (not shown).

Cross section side view 274, which may be similar to cross section side view 272, includes PIC 262, housing 222, lens 224, and epoxy 227. However, an oxide layer 263 is on a surface of the PIC 262, and abuts the housing 222. Cross section side view 276, which may be similar to cross section side view 274, includes PIC 262, oxide layer 263, housing 222, and lens 224. In addition, a cylindrical lens 268 may be etched on the silicon within an optical path between the oxide 263 and the lens 224. The cylindrical lens 268, which may be a horizontal cylindrical lens in silicon, may be paired with a vertical cylindrically etched facet in the PIC 262 (not shown) for beam focusing.

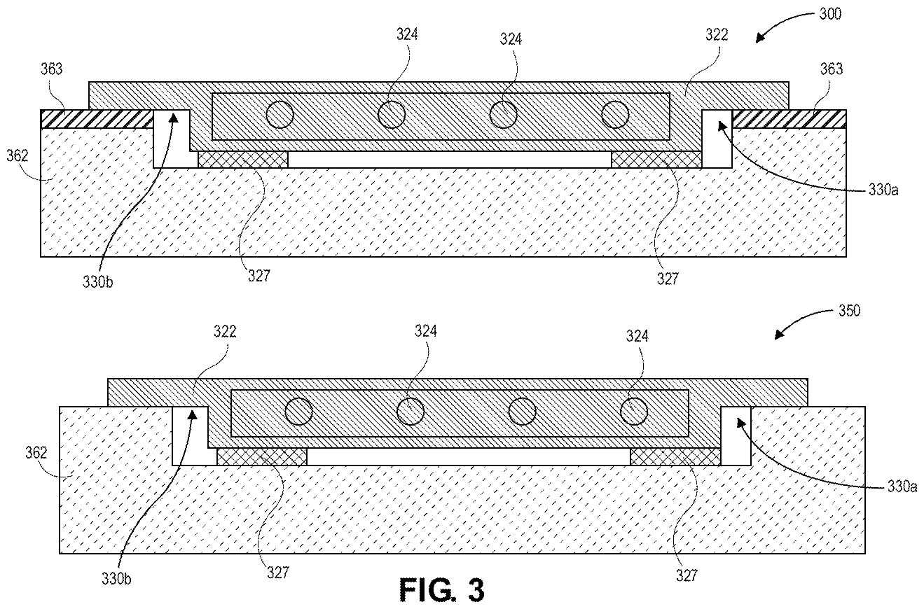

FIG. 3 illustrates various cross section front views of a silicon lens with alignment facets coupled with a PIC, in accordance with various embodiments. Cross section front view 300 shows the silicon lens housing 322, and one or more lenses 324, which may be similar to housing 122 and one or more lenses 124 of FIG. 1. Alignment facets 330a, 330b are on an oxide layer 363, which may be similar to oxide layer 263 of FIG. 2, and support and/or align the one or more lenses 324 with respect to the PIC 362, which may be similar to PIC 162 of FIG. 1. In embodiments, epoxy 327 may be placed between the PIC 362 and the housing 322 to provide additional alignment and support for the one or more lenses 324. Cross section front view 350, which may be similar to cross section front view 300, shows the alignment facets 330a, 330b placed directly on a surface of the PIC 362.

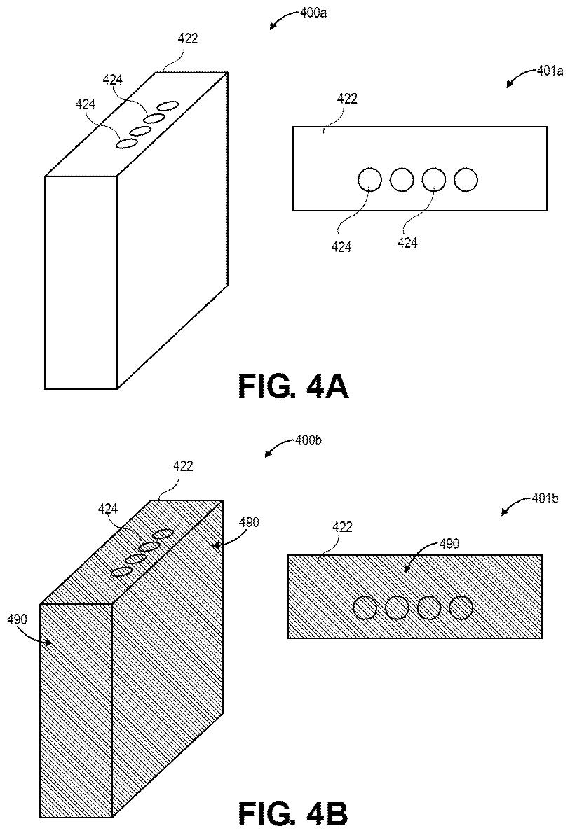

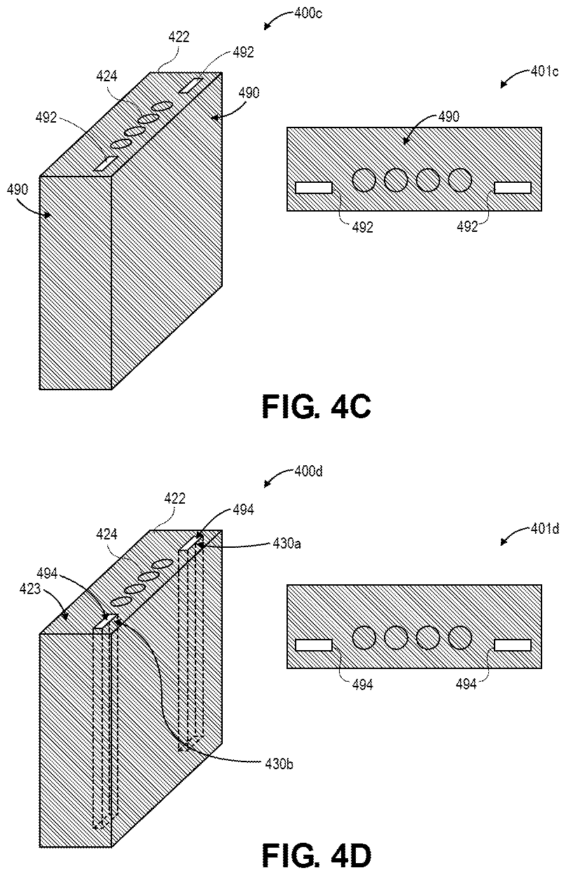

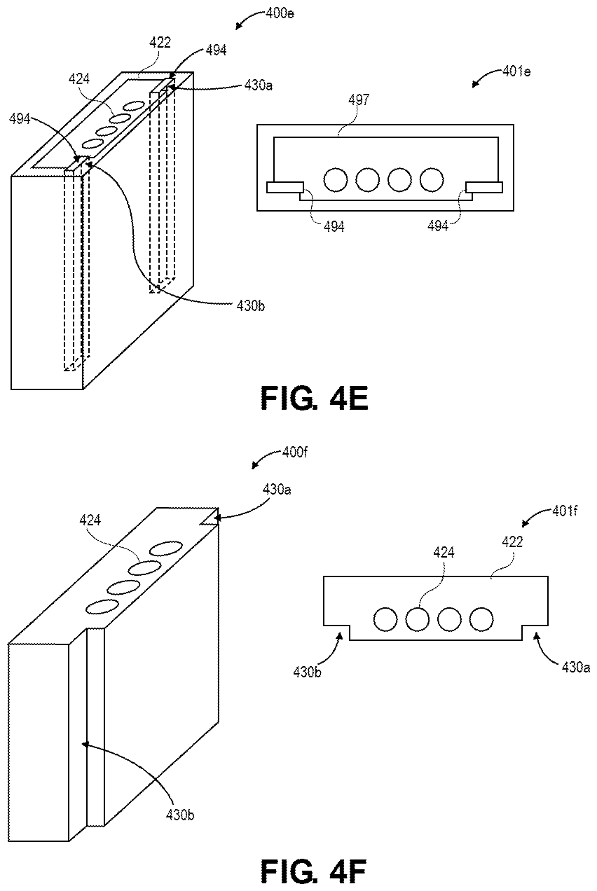

FIGS. 4A-4F illustrate stages in the manufacturing process for creating a silicon lens with alignment facets using crystallographical etching, in accordance with various embodiments. FIG. 4A shows a perspective view 400a and a top-down view 401a of a stage in the manufacturing process where a silicon layer 422 and one or more lenses 424, which may be similar to silicon lens housing 122 and one or more lenses 124 of FIG. 1 are provided. Note that the orientation of the silicon layer 422 is vertical with respect to the fabrication process. In embodiments, the silicon layer 422 is a 110-oriented silicon wafer. Known processes may be used to create the one or more lenses 424 within the silicon layer 422.

FIG. 4B shows a perspective view 400b and a top-down view 401b of a stage in the manufacturing process where the silicon layer 422 and the one or more lenses 424 are coated with a masking material 490. In embodiments, the masking material may be silicon nitride (SiN) that may be deposited using a low-pressure chemical vapor deposition (LPCVD) process. In embodiments, the masking material 490 chosen is to mask against crystallographic etchants applied during subsequent manufacturing stages. In embodiments, the entire silicon layer 422 (front, back, edges) may receive a coating of the masking material 490 to protect against unwanted etching.

FIG. 4C shows a perspective view 400c and a top-down view 401c of a stage in the manufacturing process where the masking material 490 is patterned, creating areas 492 where the masking material 490 has been removed.

FIG. 4D shows a perspective view 400d and a top-down view 401d of a stage in the manufacturing process where the silicon layer 422 is etched to open the areas where alignment facets 430a, 430b, which may be similar to 130a, 130b of FIG. 1, are desired. In embodiments, the silicon layer 422 may be immersed in a crystallographic etchant which may include but is not limited to potassium hydroxide (KOH), tetramethyl ammonium hydroxide (TMAH), or ethylene diamine pyrocatechol (EDP), which are known for etching 494 of silicon with very high selectivity to 111-planes, and creating alignment facets 430a, 430b.

Note that in the 110-oriented silicon layer 422, these alignment facets 430a, 430b are all 111-planes are orthogonal to the wafer surface 423, however other surfaces along the edge of etching 494 may be oriented at 70.52° (or 109.48°) with respect to each other. In embodiments, at least one set of 111-planes are oriented parallel to the optical axis of one or more lenses 424 so as to form alignment facets, which may also be referred to as datum, to be used for passive alignment. In embodiments, the masking material 490 is removed. In embodiments, this may be accomplished using phosphoric acid.

FIG. 4E shows a perspective view 400e and a top-down view 401e of a stage in the manufacturing process where the masking material 490 is removed, and a cutline 497 is defined to produce a shape similar to housing 122 of FIG. 1.

FIG. 4F shows a perspective view 400f and a top-down view 401f of a stage in the manufacturing process where the silicon wafer has been cut to produce housing 422 that includes lenses 424, and alignment facets 430a, 430b.

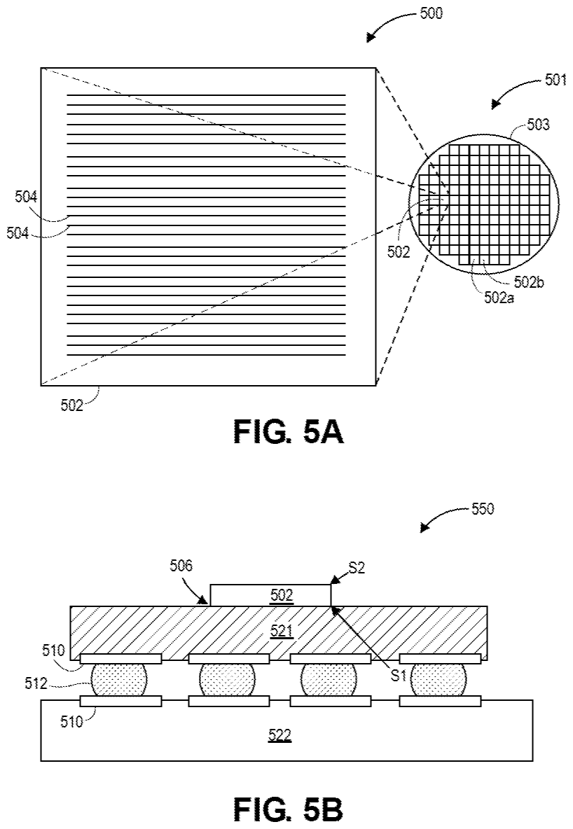

FIGS. 5A-5B schematically illustrate a top view of an example die in wafer form and in singulated form, and a cross section side view of a package assembly, in accordance with various embodiments. FIG. 5A schematically illustrates a top view of an example die 502 in a wafer form 501 and in a singulated form 500, in accordance with some embodiments. In some embodiments, die 502 may be one of a plurality of dies, e.g., dies 502, 502a, 502b, of a wafer 503 comprising semiconductor material, e.g., silicon or other suitable material. The plurality of dies, e.g., dies 502, 502a, 502b, may be formed on a surface of wafer 503. Each of the dies 502, 502a, 502b, may be a repeating unit of a semiconductor product that includes devices as described herein. For example, die 502 may include circuitry having transistor elements such as, for example, one or more channel bodies 504 (e.g., fin structures, nanowires, and the like) that provide a channel pathway for mobile charge carriers in transistor devices. Although one or more channel bodies 504 are depicted in rows that traverse a substantial portion of die 502, it is to be understood that one or more channel bodies 504 may be configured in any of a wide variety of other suitable arrangements on die 502 in other embodiments.

After a fabrication process of the device embodied in the dies is complete, wafer 503 may undergo a singulation process in which each of dies, e.g., die 502, is separated from one another to provide discrete “chips” of the semiconductor product. Wafer 503 may be any of a variety of sizes. In some embodiments, wafer 503 has a diameter ranging from about 25.4 mm to about 450 mm. Wafer 503 may include other sizes and/or other shapes in other embodiments. According to various embodiments, the one or more channel bodies 504 may be disposed on a semiconductor substrate in wafer form 501 or singulated form 500. One or more channel bodies 504 described herein may be incorporated in die 502 for logic, memory, or combinations thereof. In some embodiments, one or more channel bodies 504 may be part of a system-on-chip (SoC) assembly.

FIG. 5B schematically illustrates a cross-section side view of an integrated circuit (IC) assembly 550, in accordance with some embodiments. In some embodiments, IC assembly 550 may include one or more dies, e.g., die 502, that include lenses with alignment facets as described herein. Die 502 may include one or more channel bodies 504 that serve as channel bodies of multi-threshold voltage transistor devices. In some embodiments, package substrate 521 may be electrically coupled with a circuit board 522 as is well known to a person of ordinary skill in the art. Die 502 may represent a discrete product made from a semiconductor material (e.g., silicon) using semiconductor fabrication techniques such as thin film deposition, lithography, etching, and the like used in connection with forming Complementary Metal Oxide Semiconductor (CMOS) devices. In some embodiments, die 502 may be, include, or be a part of a processor, memory, SoC or ASIC in some embodiments.

Die 502 can be attached to package substrate 521 according to a wide variety of suitable configurations including, for example, being directly coupled with package substrate 521 in a flip-chip configuration, as depicted. In the flip-chip configuration, an active side 51 of die 502 including circuitry is attached to a surface of package substrate 521 using hybrid bonding structures as described herein that may also electrically couple die 502 with package substrate 521. Active side 51 of die 502 may include multi-threshold voltage transistor devices as described herein. An inactive side S2 of die 502 may be disposed opposite to active side 51.

In some embodiments, package substrate 521 is an epoxy-based laminate substrate having a core and/or build-up layers such as, for example, an Ajinomoto Build-up Film (ABF) substrate. Package substrate 521 may include other suitable types of substrates in other embodiments including, for example, substrates formed from glass, ceramic, or semiconductor materials.

Package substrate 521 may include electrical routing features configured to route electrical signals to or from die 502. The electrical routing features may include pads or traces (not shown) disposed on one or more surfaces of package substrate 521 and/or internal routing features (not shown) such as trenches, vias, or other interconnect structures to route electrical signals through package substrate 521. In some embodiments, package substrate 521 may include electrical routing features such as pads (not shown) configured to receive the respective die-level interconnect structures 506 of die 502.

Circuit board 522 may be a printed circuit board (PCB) comprising an electrically insulative material such as an epoxy laminate. Circuit board 522 may include electrically insulating layers composed of materials such as, for example, polytetrafluoroethylene, phenolic cotton paper materials such as Flame Retardant 4 (FR-4), FR-1, cotton paper and epoxy materials such as CEM-1 or CEM-3, or woven glass materials that are laminated together using an epoxy resin prepreg material. Interconnect structures such as traces, trenches, vias may be formed through the electrically insulating layers to route the electrical signals of die 502 through circuit board 522. Circuit board 522 may comprise other suitable materials in other embodiments. In some embodiments, circuit board 522 is a motherboard as is well known to a person of ordinary skill in the art.

Package-level interconnects such as, for example, solder balls 512 may be coupled to one or more pads 510 on package substrate 521 and/or on circuit board 522 to form corresponding solder joints that are configured to further route the electrical signals between package substrate 521 and circuit board 522. Pads 510 may comprise any suitable electrically conductive material such as metal including, for example, nickel (Ni), palladium (Pd), gold (Au), silver (Ag), copper (Cu), and combinations thereof. Other suitable techniques to physically and/or electrically couple package substrate 521 with circuit board 522 may be used in other embodiments.

IC assembly 550 may include a wide variety of other suitable configurations in other embodiments including, for example, suitable combinations of flip-chip and/or wire-bonding configurations, interposers, multi-chip package configurations including system-in-package (SiP), and/or package-on-package (PoP) configurations. Other suitable techniques to route electrical signals between die 502 and other components of IC assembly 550 may be used in some embodiments.

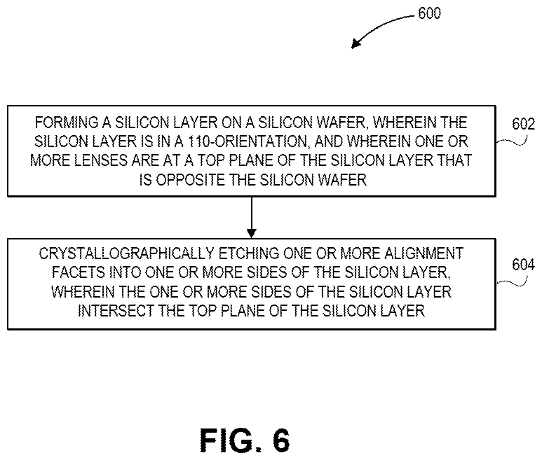

FIG. 6 illustrates an example of a process for creating a silicon lens with alignment facets using crystallographical etching, in accordance with various embodiments. Process 600 may be performed by one or more elements, techniques, or systems that may be described herein, and in particular with respect to FIGS. 1-5B.

At block 602, the process may include forming a silicon layer on a silicon wafer, wherein the silicon layer is in a 110 orientation, and wherein one or more lenses are at a top plane of the silicon layer that is opposite the silicon wafer.

At block 604, the process may further include crystallographically etching one or more alignment facets into one or more sides of the silicon layer, wherein the one or more sides of the silicon layer intersect the top plane of the silicon layer.

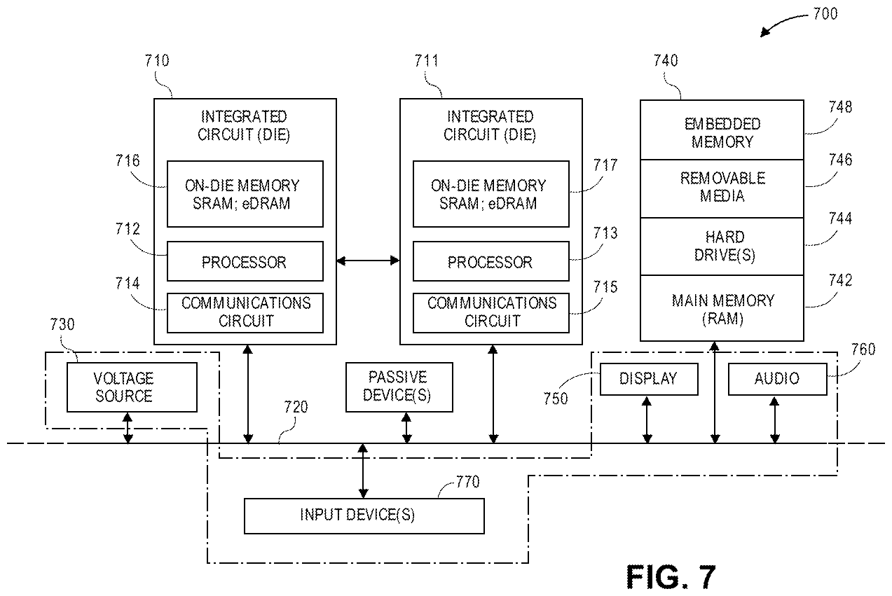

FIG. 7 is a schematic of a computer system 700, in accordance with an embodiment of the present invention. The computer system 700 (also referred to as the electronic system 700) as depicted can embody a lens with alignment facets, according to any of the several disclosed embodiments and their equivalents as set forth in this disclosure. The computer system 700 may be a mobile device such as a netbook computer. The computer system 700 may be a mobile device such as a wireless smart phone. The computer system 700 may be a desktop computer. The computer system 700 may be a hand-held reader. The computer system 700 may be a server system. The computer system 700 may be a supercomputer or high-performance computing system.

In an embodiment, the electronic system 700 is a computer system that includes a system bus 720 to electrically couple the various components of the electronic system 700. The system bus 720 is a single bus or any combination of busses according to various embodiments. The electronic system 700 includes a voltage source 730 that provides power to the integrated circuit 710. In some embodiments, the voltage source 730 supplies current to the integrated circuit 710 through the system bus 720.

The integrated circuit 710 is electrically coupled to the system bus 720 and includes any circuit, or combination of circuits according to an embodiment. In an embodiment, the integrated circuit 710 includes a processor 712 that can be of any type. As used herein, the processor 712 may mean any type of circuit such as, but not limited to, a microprocessor, a microcontroller, a graphics processor, a digital signal processor, or another processor. In an embodiment, the processor 712 includes, or is coupled with, a lens with alignment facets, as disclosed herein. In an embodiment, SRAM embodiments are found in memory caches of the processor. Other types of circuits that can be included in the integrated circuit 710 are a custom circuit or an application-specific integrated circuit (ASIC), such as a communications circuit 714 for use in wireless devices such as cellular telephones, smart phones, pagers, portable computers, two-way radios, and similar electronic systems, or a communications circuit for servers. In an embodiment, the integrated circuit 710 includes on-die memory 716 such as static random-access memory (SRAM). In an embodiment, the integrated circuit 710 includes embedded on-die memory 716 such as embedded dynamic random-access memory (eDRAM).

In an embodiment, the integrated circuit 710 is complemented with a subsequent integrated circuit 711. Useful embodiments include a dual processor 713 and a dual communications circuit 715 and dual on-die memory 717 such as SRAM. In an embodiment, the dual integrated circuit 710 includes embedded on-die memory 717 such as eDRAM.

In an embodiment, the electronic system 700 also includes an external memory 740 that in turn may include one or more memory elements suitable to the particular application, such as a main memory 742 in the form of RAM, one or more hard drives 744, and/or one or more drives that handle removable media 746, such as diskettes, compact disks (CDs), digital variable disks (DVDs), flash memory drives, and other removable media known in the art. The external memory 740 may also be embedded memory 748 such as the first die in a die stack, according to an embodiment.

In an embodiment, the electronic system 700 also includes a display device 750, an audio output 760. In an embodiment, the electronic system 700 includes an input device such as a controller 770 that may be a keyboard, mouse, trackball, game controller, microphone, voice-recognition device, or any other input device that inputs information into the electronic system 700. In an embodiment, an input device 770 is a camera. In an embodiment, an input device 770 is a digital sound recorder. In an embodiment, an input device 770 is a camera and a digital sound recorder.

As shown herein, the integrated circuit 710 can be implemented in a number of different embodiments, including a package substrate having a lens with alignment facets, according to any of the several disclosed embodiments and their equivalents, an electronic system, a computer system, one or more methods of fabricating an integrated circuit, and one or more methods of fabricating an electronic assembly that includes a package substrate having a lens with alignment facets, according to any of the several disclosed embodiments as set forth herein in the various embodiments and their art-recognized equivalents. The elements, materials, geometries, dimensions, and sequence of operations can all be varied to suit particular I/O coupling requirements including array contact count, array contact configuration for a microelectronic die embedded in a processor mounting substrate according to any of the several disclosed package substrates having a lens with alignment facets embodiments and their equivalents. A foundation substrate may be included, as represented by the dashed line of FIG. 7. Passive devices may also be included, as is also depicted in FIG. 7.

### EXAMPLES

The following paragraphs describe examples of various embodiments.

Example 1 is an apparatus comprising: a silicon layer with a first side and a second side opposite the first side; one or more lenses at an edge of the silicon layer, the edge intersecting the first side and the second side of the silicon layer; one or more alignment facets on the second side of the silicon layer, wherein a plane of the one or more alignment facets is substantially parallel to the first side of the silicon layer; and wherein the one or more alignment facets include a 111 plane of the silicon layer.

Example 2 may include the apparatus of example 1, or of any other example or embodiments herein, wherein the silicon layer is a 110 oriented silicon layer.

Example 3 may include the apparatus of example 1, or of any other example or embodiment described herein, wherein the one or more alignment facets are crystallographically defined.

Example 4 may include the apparatus of example 1, or of any other example or embodiment described herein, wherein the edge is a first edge; and further comprising a second edge opposite the first edge, wherein an alignment facet is at a third edge of the second side of the silicon layer extending from the first edge to the second edge.

Example 5 may include the apparatus of example 4, or of any other example or embodiment described herein, wherein the alignment facet is a first alignment facet; and further comprising a second alignment facet at a fourth edge of the second side of the silicon layer opposite the third edge, the second alignment facet extending from the first edge to the second edge.

Example 6 may include the apparatus of example 5, or of any other example or embodiment described herein, wherein none of the one or more lenses is above the first alignment facet or the second alignment facet with respect to a plane of the first side of the silicon layer.

Example 7 may include the apparatus of example 5, or of any other example or embodiment described herein, further comprising a third alignment facet at a fifth edge of the second side of the silicon layer opposite the first edge, the third alignment facet extending from the first alignment facet to the second alignment facet.

Example 8 may include the apparatus of example 1, or of any other example or embodiment described herein, wherein the plane of the one or more alignment facets intersects the one or more lenses.

Example 9 may include the apparatus of example 1, or of any other example or embodiment described herein, wherein all of the one or more alignment facets are in a plane.

Example 10 may include the apparatus of example 1, or of any other example or embodiment described herein, wherein the edge is a first edge; and further comprising: a second edge opposite the first edge; and one or more optical pathways that are optically coupled, respectively, with the one or more lenses, wherein the one or more optical pathways extend to the second edge.

Example 11 may include the apparatus of example 10, or of any other example or embodiment described herein, wherein the one or more optical pathways are optical waveguides.

Example 12 may include the apparatus of example 10, or of any other example or embodiment described herein, wherein the one or more optical pathways are substantially parallel.

Example 13 may include the apparatus of example 1, or of any other example or embodiment described herein, wherein the plane of the one or more alignment facets is a first plane; and wherein a center of each of the one or more lenses are aligned in a second plane that is substantially parallel to the first side of the silicon layer.

Example 14 may include the apparatus of example 1, or of any other example or embodiment described herein, wherein a cross section, which is perpendicular to the first side and to the second side of the silicon layer, of the edge forms a plane curve.

Example 15 may include the apparatus of example 1, or of any other example or embodiment described herein, wherein the one or more lenses are in a plurality of rows with respect to the plane of the one or more alignment facets.

Example 16 is a method comprising: forming a silicon layer on a silicon wafer, wherein the silicon layer is made from a (110)-oriented Si wafer such that one or more lenses are at a top plane of the silicon layer that is opposite the silicon wafer; and crystallographically etching one or more (111)-oriented alignment facets into one or more sides of the silicon layer, wherein the one or more sides of the silicon layer intersect the top plane of the silicon layer.

Example 17 may include the method of example 16, or of any other example or embodiment described herein, further comprising forming one or more lenses at the top plane of the silicon layer.

Example 18 may include the method of example 16, or of any other example or embodiment described herein, wherein crystallographically etching the one or more alignment facets further includes: applying a mask to the silicon layer; patterning the applied mask; and forming the one or more alignment facets that are in a 111 plane by immersing the silicon layer into a crystallographic etchant.

Example 19 may include the method of example 18, or of any other example or embodiment described herein, wherein the crystallographic etchant includes a selected one or more of: potassium hydroxide (KOH), tetra methyl ammonium hydroxide (TMAH), ethylene diamine pyrocatechol (EDP), or any other crystallographic etchant that is selective to the 111 plane.

Example 20 is a package comprising: an optical coupler that includes: one or more lenses on an edge of the silicon layer, the edge intersecting the first side and the second side of the silicon layer; one or more alignment facets on the second side of the silicon layer, wherein a plane of the one or more alignment facets is substantially parallel to the first side of the silicon layer; and wherein the one or more alignment facets include a 111 plane of the silicon layer; a photonics integrated circuit (PIC) that includes: a first side of the PIC, a second side of the PIC opposite the first side, and a first edge of the PIC that intersects the first side and the second side; a cavity within the PIC, the cavity extending from the first side of the PIC toward the second side of the PIC, and from the first edge of the PIC toward a second edge of the PIC opposite the first edge, wherein the cavity extends toward but does not reach a third edge of the PIC that intersects the first side, the second side, the first edge, and the second edge, and wherein the cavity extends toward but does not reach a fourth edge of the PIC opposite the third edge of the PIC; and wherein at least a portion of the optical coupler is inserted within the cavity and wherein the one or more alignment facets are adjacent to the first side of the PIC.

Example 21 may include the package of example 20, or of any other example or embodiment described herein, wherein the silicon layer is a 110 oriented silicon layer.

Example 22 may include the package of example 20, or of any other example or embodiment described herein, wherein the one or more alignment facets are crystallographically defined.

Example 23 may include the package of example 20, or of any other example or embodiment described herein, wherein the PIC includes one or more optical paths that optically couple with the one or more lenses of the optical coupler.

Example 24 may include the package of example 20, or of any other example or embodiment described herein, further comprising a support material coupled with the second side of the optical coupler and a bottom of the cavity.

Example 25 may include the package of example 22, or of any other example or embodiment described herein, wherein the support material includes epoxy.

Various embodiments may include any suitable combination of the above-described embodiments including alternative (or) embodiments of embodiments that are described in conjunctive form (and) above (e.g., the “and” may be “and/or”). Furthermore, some embodiments may include one or more articles of manufacture (e.g., non-transitory computer-readable media) having instructions, stored thereon, that when executed result in actions of any of the above-described embodiments.

Moreover, some embodiments may include apparatuses or systems having any suitable means for carrying out the various operations of the above-described embodiments. The above description of illustrated embodiments, including what is described in the Abstract, is not intended to be exhaustive or to limit embodiments to the precise forms disclosed. While specific embodiments are described herein for illustrative purposes, various equivalent modifications are possible within the scope of the embodiments, as those skilled in the relevant art will recognize.

These modifications may be made to the embodiments in light of the above detailed description. The terms used in the following claims should not be construed to limit the embodiments to the specific implementations disclosed in the specification and the claims. Rather, the scope of the invention is to be determined entirely by the following claims, which are to be construed in accordance with established doctrines of claim interpretation.

What is claimed is:

1. An apparatus comprising:
a silicon layer with a first side and a second side opposite the first side;
one or more lenses at an edge of the silicon layer, the edge intersecting the first side and the second side of the silicon layer;
one or more alignment facets on the second side of the silicon layer, wherein a plane of the one or more alignment facets is substantially parallel to the first side of the silicon layer; and
wherein the one or more alignment facets include a 111 plane of the silicon layer.

2. The apparatus of claim 1, wherein the silicon layer is a 110 oriented silicon layer.

3. The apparatus of claim 1, wherein the one or more alignment facets are crystallographically defined.

4. The apparatus of claim 1, wherein the edge is a first edge; and further comprising a second edge opposite the first edge, wherein an alignment facet is at a third edge of the second side of the silicon layer extending from the first edge to the second edge.

5. The apparatus of claim 4, wherein the alignment facet is a first alignment facet; and further comprising a second alignment facet at a fourth edge of the second side of the silicon layer opposite the third edge, the second alignment facet extending from the first edge to the second edge.

6. The apparatus of claim 5, wherein none of the one or more lenses is above the first alignment facet or the second alignment facet with respect to a plane of the first side of the silicon layer.

7. The apparatus of claim 5, further comprising a third alignment facet at a fifth edge of the second side of the silicon layer opposite the first edge, the third alignment facet extending from the first alignment facet to the second alignment facet.

8. The apparatus of claim 1, wherein the plane of the one or more alignment facets intersects the one or more lenses.

9. The apparatus of claim 1, wherein all of the one or more alignment facets are in a plane.

10. The apparatus of claim 1, wherein the edge is a first edge; and further comprising:
a second edge opposite the first edge; and
one or more optical pathways that are optically coupled, respectively, with the one or more lenses, wherein the one or more optical pathways extend to the second edge.

11. The apparatus of claim 10, wherein the one or more optical pathways are optical waveguides.

12. The apparatus of claim 10, wherein the one or more optical pathways are substantially parallel.

13. The apparatus of claim 1, wherein the plane of the one or more alignment facets is a first plane; and
wherein a center of each of the one or more lenses are aligned in a second plane that is substantially parallel to the first side of the silicon layer.

14. The apparatus of claim 1, wherein a cross section, which is perpendicular to the first side and to the second side of the silicon layer, of the edge forms a plane curve.

15. The apparatus of claim 1, wherein the one or more lenses are in a plurality of rows with respect to the plane of the one or more alignment facets.

16. A method comprising:
forming a silicon layer on a silicon wafer, wherein the silicon layer is made from a (110) oriented Si wafer such that one or more lenses are at a top plane of the silicon layer that is opposite the silicon wafer; and
crystallographically etching one or more (111)-oriented alignment facets into one or more sides of the silicon layer, wherein the one or more sides of the silicon layer intersect the top plane of the silicon layer.

17. The method of claim 16, further comprising forming one or more lenses at the top plane of the silicon layer.

18. The method of claim 16, wherein crystallographically etching the one or more alignment facets further includes:
applying a mask to the silicon layer;
patterning the applied mask; and
forming the one or more alignment facets that are in a 111 plane by immersing the silicon layer into a crystallographic etchant.

19. The method of claim 18, wherein the crystallographic etchant includes a selected one or more of: potassium hydroxide (KOH), tetra methyl ammonium hydroxide (TMAH), ethylene diamine pyrocatechol (EDP), or any other crystallographic etchant that is selective to the 111 plane.

20. A package comprising:
an optical coupler that includes:
one or more lenses on an edge of the silicon layer, the edge intersecting the first side and the second side of the silicon layer;
one or more alignment facets on the second side of the silicon layer, wherein a plane of the one or more alignment facets is substantially parallel to the first side of the silicon layer; and
wherein the one or more alignment facets include a 111 plane of the silicon layer;
a photonics integrated circuit (PIC) that includes:
a first side of the PIC, a second side of the PIC opposite the first side, and a first edge of the PIC that intersects the first side and the second side;
a cavity within the PIC, the cavity extending from the first side of the PIC toward the second side of the PIC, and from the first edge of the PIC toward a second edge of the PIC opposite the first edge,
wherein the cavity extends toward but does not reach a third edge of the PIC that intersects the first side, the second side, the first edge, and the second edge, and
wherein the cavity extends toward but does not reach a fourth edge of the PIC opposite the third edge of the PIC; and
wherein at least a portion of the optical coupler is inserted within the cavity and wherein the one or more alignment facets are adjacent to the first side of the PIC.

21. The package of claim 20, wherein the silicon layer is a 110 oriented silicon layer.

22. The package of claim 20, wherein the one or more alignment facets are crystallographically defined.

23. The package of claim 20, wherein the PIC includes one or more optical paths that optically couple with the one or more lenses of the optical coupler.

24. The package of claim 20, further comprising a support material coupled with the second side of the optical coupler and a bottom of the cavity.

25. The package of claim 22, wherein the support material includes epoxy.
